(19) United States
(12) Patent Application Publication
(10) Pub. No.: US 2010/0271367 A1
(43) Pub. Date: Oct. 28, 2010

(54) METHOD AND APPARATUS FOR COMBINING A REAL WORLD EVENT AND A COMPUTER SIMULATION

(75) Inventors: Mark Vaden, San Diego, CA (US); Ramana B. Prakash, San Diego, CA (US)

Correspondence Address: FITCH EVEN TABIN & FLANNERY, 120 SOUTH LASALLE STREET, SUITE 1600, CHICAGO, IL, 60603-3406, US

(73) Assignee: SONY COMPUTER ENTERTAINMENT AMERICA INC., Foster City, CA (US)

(21) Appl. No.: 12/428,423

(22) Filed: Apr. 22, 2009

(51) Int. Cl. G06T 17/00; H04N 7/18

(52) U.S. Cl. 345/420; 348/157

(57) ABSTRACT

A method for use in a computer simulation includes receiving data obtained from a real-world event that takes place over a period of time and that includes a plurality of moving bodies, wherein the data includes position data and at least one other attribute for each moving body in the plurality of moving bodies with the data being measured at a plurality of points in the period of time, generating a representation of the real-world event using the data, wherein the representation of the real-world event comprises representations of the plurality of moving bodies, and rendering the representation of the real-world event on a display. Another method includes obtaining data for each of a plurality of moving bodies in a real-world event, and providing the data to an apparatus that is configured to use the data to generate a representation of the real-world event and render the representation of the real-world event on a display. A computer readable storage medium stores a computer program adapted to cause a processor based system to execute one or more of the above or similar steps. An apparatus is configured to generate and render a representation of the real-world event using data obtained from the real-world event.

### BACKGROUND OF THE INVENTION

1. Field of the Invention

The present invention relates generally to computer simulations, such as video games, and more specifically to methods and techniques for making computer simulations more realistic.

2. Discussion of the Related Art

Computer simulations, such as video games, have become a popular form of entertainment. Commercially available game consoles allow users to play video games in the comfort of their own homes. Advancements in computer graphics, processing power, and rendering technology have enabled the development of video games and other computer simulations that have a very realistic appearance. Some games become extremely popular, generating huge revenues, which leaves the video gaming industry constantly trying to develop the next hit video game.

### SUMMARY OF THE INVENTION

One embodiment provides a method for use in a computer simulation, comprising: receiving data obtained from a real-world event that takes place over a period of time and that includes a plurality of moving bodies, wherein the data includes position data and at least one other attribute for each moving body in the plurality of moving bodies with the data being measured at a plurality of points in the period of time; generating a representation of the real-world event using the data, wherein the representation of the real-world event comprises representations of the plurality of moving bodies; and rendering the representation of the real-world event on a display.

Another embodiment provides a computer readable storage medium storing a computer program adapted to cause a processor based system to execute steps comprising: receiving data obtained from a real-world event that takes place over a period of time and that includes a plurality of moving bodies, wherein the data includes position data and at least one other attribute for each moving body in the plurality of moving bodies with the data being measured at a plurality of points in the period of time; generating a representation of the real-world event using the data, wherein the representation of the real-world event comprises representations of the plurality of moving bodies; and rendering the representation of the real-world event on a display.

Another embodiment provides a method, comprising: obtaining position data for each of a plurality of moving bodies in a real-world event that takes place over a period of time and that is broadcast on television to at least some viewers, wherein the position data is obtained at a plurality of points in the period of time; and providing the position data to an apparatus that is configured to use the position data to generate a representation of the real-world event and render the representation of the real-world event on a display, wherein the representation of the real-world event comprises representations of the plurality of moving bodies.

Another embodiment provides a computer readable storage medium storing a computer program adapted to cause a processor based system to execute steps comprising: receiving data obtained from a real-world event that includes a plurality of moving bodies; wherein the real-world event takes place over a period of time and is broadcast on television to at least some viewers; and wherein the data includes position data for each moving body in the plurality of moving bodies with the data being obtained at a plurality of points in the period of time; generating a representation of the real-world event using the data, wherein the representation of the real-world event comprises representations of the plurality of moving bodies; and rendering the representation of the real-world event on a display.

Another embodiment provides a computer readable storage medium storing a computer program adapted to cause a processor based system to execute steps comprising: receiving data obtained from a real-world event that takes place over a period of time and that includes a plurality of moving bodies; wherein the data includes position data for each moving body in the plurality of moving bodies with the data being obtained at a plurality of points in the period of time; and wherein the data includes data obtained by analyzing one or more videos of the real-world event; generating a representation of the real-world event using the data, wherein the representation of the real-world event comprises representations of the plurality of moving bodies; and rendering the representation of the real-world event on a display.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIG. 1A is a picture illustrating a real world event;

FIG. 1B is a rendered representation of the real world event of FIG. 1A made in accordance with an embodiment of the present invention;

FIGS. 2, 3, 4 and 5 are flow diagrams illustrating methods for use in a computer simulation in accordance with an embodiment of the present invention;

FIG. 6 is a timing diagram illustrating a feature in accordance with an embodiment of the present invention;

FIG. 7 is a timing diagram illustrating a feature in accordance with an embodiment of the present invention;

FIGS. 8, 9 and 10 are timing diagrams illustrating the interactions of moving bodies in accordance with embodiments of the present invention;

FIG. 11 is a flow diagram illustrating methods in accordance with embodiments of the present invention;

FIG. 12 is a pictorial diagram illustrating methods for tracking a moving body in accordance with embodiments of the present invention;

FIG. 13 is a block diagram illustrating a system that may be used to run, implement and/or execute the methods and/or techniques shown and described herein in accordance with embodiments of the present invention; and

FIG. 14 is a block diagram illustrating a processor based system that may be used to run, implement and/or execute the methods and/or techniques shown and described herein in accordance with embodiments of the present invention.

### DETAILED DESCRIPTION

Video game users are often impressed by graphics that have a very realistic appearance. It is believed by the inventor hereof that such users are not only interested in viewing realistic graphics, but are also desirous of obtaining an overall more realistic experience while playing video games.

Embodiments of the present invention combine real world events with computer simulations, such as video games. This combination provides a “real world” experience for the player.

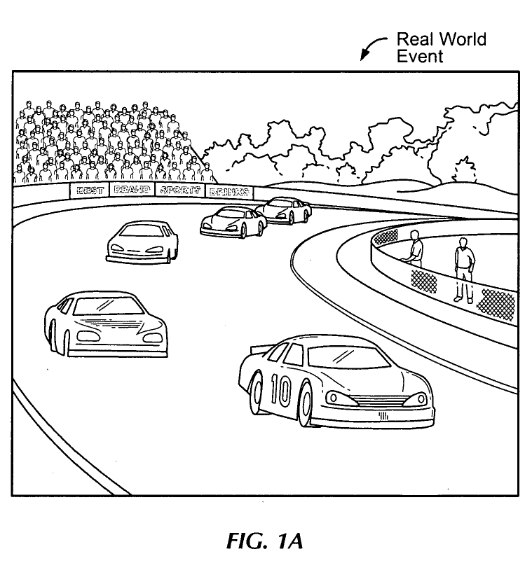

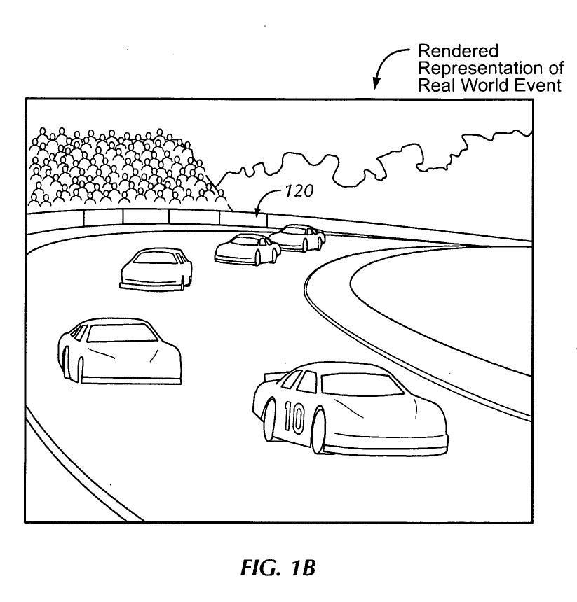

For example, in some embodiments, a real world automobile racing event, such as a NASCAR race, is combined with a computer simulation. Specifically, FIG. 1A is a picture of an actual, or “real world,” automobile racing event. Teams in NASCAR, F1, Indy, and Champ car racing events currently gather vehicular data using accelerometers, GPS (Global Positioning Satellite), and other techniques. For example, by using GPS, the position of each car is continually recorded as it moves along the race track.

In embodiments of the present invention, this vehicular data is used to generate and render a representation of the real race in a video game or other computer simulation. An example of one frame of such a representation is shown in FIG. 1B. The representation of the real race includes representations of each of the race cars. That is, the representation of the real race includes representations of each of the moving bodies. The movements of each car in the representation is in accordance with the vehicular data obtained from the real race.

The rendered representation of the real race effectively provides the player with the opportunity to compete in the real race against the actual race cars, which gives that user a real world experience. In some embodiments, the vehicular data is recorded and stored for later use in a video game. Or, in some embodiments, the vehicular data is streamed live over the Internet so the player can play against the real event while it was happening. The rendered representation of the real race also has other uses. For example, in some embodiments the advertisements in the rendered representation can be changed from what is in the real world event. For example, different advertisements can be inserted into the advertising spaces 120 in the rendered representation of the real race. That is, in some embodiments the advertisements that are located in the advertising spaces 120 may be the same as in the real world event, or in some embodiments the advertisements that are located in the advertising spaces 120 may be different than in the real world event.

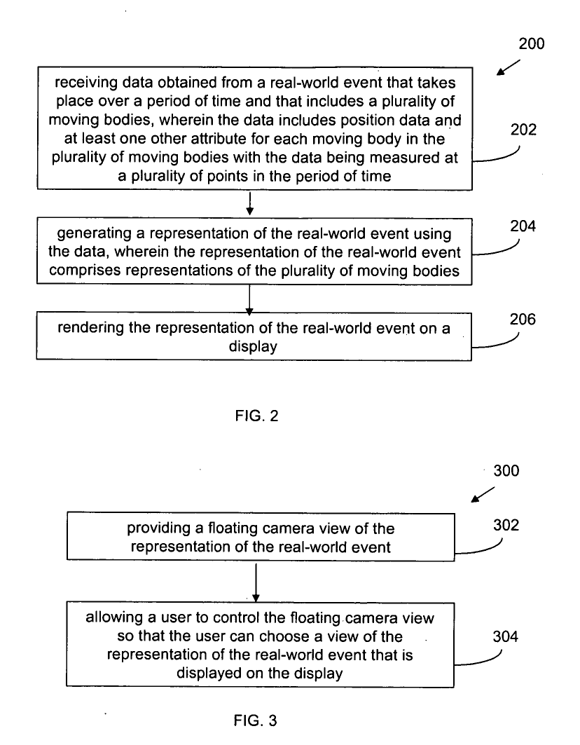

Referring to FIG. 2, there is illustrated a method 200 that operates in accordance with an embodiment of the present invention. The method 200 may be used for implementing the above-described techniques in a computer simulation. The method 200 begins in step 202 in which data obtained from a real-world event is received. In this embodiment, the real-world event takes place over a period of time and includes a plurality of moving bodies, such as automobiles or other vehicles. As will be discussed below, in some embodiments a moving body may comprise a human being, such as a player in the real world event, or some other person. In some embodiments, a moving body may comprise an object, such as a ball, bat, or other object that is moving or being manipulated in the real world event.

The data includes position data and at least one other attribute for each moving body. By way of example, in the automobile racing context, such attributes may include speed, tire pressure, tire temperature, water temperature, oil temperatures, fuel level, and tachometer readings for each moving body. In addition, the data may be dynamic GPS information of each moving body along with various attributes of each moving body. For example, NASCAR races monitor various attributes of each car during each race. The data gathered during NASCAR races may be utilized as the received data in accordance with one embodiment of the invention. In some embodiments, the data is received and stored onto a hard drive or other recordable media to be later utilized in a video game or other computer simulation. In other embodiments, the data is streamed live and utilized in the video game or other computer simulation.

The data obtained from a real-world event is measured at a plurality of points in time during the real-world event. As attributes for each moving body is measured, the measured values of the attributes may be sampled at a plurality of points in time so the received data from the real world event comprises a finite set of data. In another embodiment, the attributes of each moving body is measured at a plurality of points in time. The measured values are then received as data obtained from the real-world event. In another embodiment, the data is sampled once it is received at step 202.

In step 204, a representation of the real-world event is generated using the data. The representation of the real-world event includes representations of the plurality of moving bodies. The received data corresponding to the real-world event may be utilized to generate a representation of the real-world event. In addition, the received data may be utilized to generate the plurality of moving bodies within the real-world event and determine how the representations of the plurality of moving bodies interact within the representation of the real-world event with each other.

In one embodiment, the real-world event is a vehicle race and the plurality of moving bodies are the various vehicles competing in the vehicle race (such as NASCAR, F1, Indy, and Champ car racing events). Received data corresponding to vehicular data may be utilized to generate representations of the vehicles from a real-world event in the representation of the real-world event. For example, GPS or position data may be utilized to generate representations of the vehicles at their respective positions at any given point in time. As the real-world event is simulated, the received data is also utilized to simulate the vehicles within the simulated real-world event with their corresponding position and speed, along with various vehicular attributes. By utilizing the received data obtained from the real-world event (in this case, a vehicle race), the real-world event and the moving bodies may be simulated with greater precision.

In step 206 the representation of the real-world event is rendered on a display. Once the representation of the real-world event, along with the representations of the plurality of moving bodies is generated, the representations are then rendered upon a display for a user to view or interact with (further discussion of the interaction with the rendered representation of real-world event shall be discussed with regard to the remaining figures). The display is configured to display images to a user, such as an LCD, DLP, CRT display, or a plasma display. In addition, the display may be a television system utilized with a video game console or a monitor utilized with a computer. FIGS. 1A and 1B illustrate the real-world event and one frame of the representation of the real-world event which may be rendered upon a display.

Referring to FIG. 3, there is illustrated a method 300 that operates in accordance with an embodiment of the present invention. The method 300 may be used for allowing user manipulation of the representation of the real world event. The method 300 begins in step 302 in which a floating camera view of the representation of the real-world event is provided.

Camera views utilized at the real-world event are typically stationary and fixed in locked positions. However, once the representation of the real-world event has been generated, the floating camera view may provide unique perspectives, beyond the views provided by a camera at a real-world event, of the representation of the real-world event and the real-world event itself since data obtained from the real-world event is utilized to generate the representation of the real-world event. The floating camera view may provide views such as zooming and rotating (spinning) in any direction, along with a bird's eye view of the representation of the real-world event. In addition, the floating camera view may lock onto any one of the representations of the plurality of moving bodies. The floating camera view may also provide a view from the perspective of one of the plurality of moving bodies, along with a reverse view from any one of the plurality of moving bodies.

In step 304, control of the floating camera view by a user is allowed so the user may choose a view of the representation of the real-world event that is displayed on the display. The user may control the floating camera view of the representation of the real-world event and the representations of the moving bodies of the real-world event. As the user manipulates the floating camera view, the view of the representation of the real-world event is displayed on the display.

In one embodiment, the real-world event is a vehicle racing event and the user may utilize the floating camera view to further view the vehicle racing event. The representation of the real-world event may include representations of the vehicles participating in the vehicle racing event. In addition, representation of the vehicles may also include an additional vehicle which was not initially participating in the real-world event. The user may utilized the floating point camera to zoom in and out of any aspect of the representation of the racing event, such as viewing the entire track or a specific portion of the track. Additionally, the floating camera view allows the user to view additional or alternative views of any one of the vehicles in the racing event. The user may lock onto and zoom into any one of the vehicles in the racing event and rotate the floating camera view around any one of the vehicles. In addition, the floating camera view may be placed within any one of the vehicles, to view the forward or reverse (look behind the vehicle, rear-view mirror view) vehicle perspective of the race.

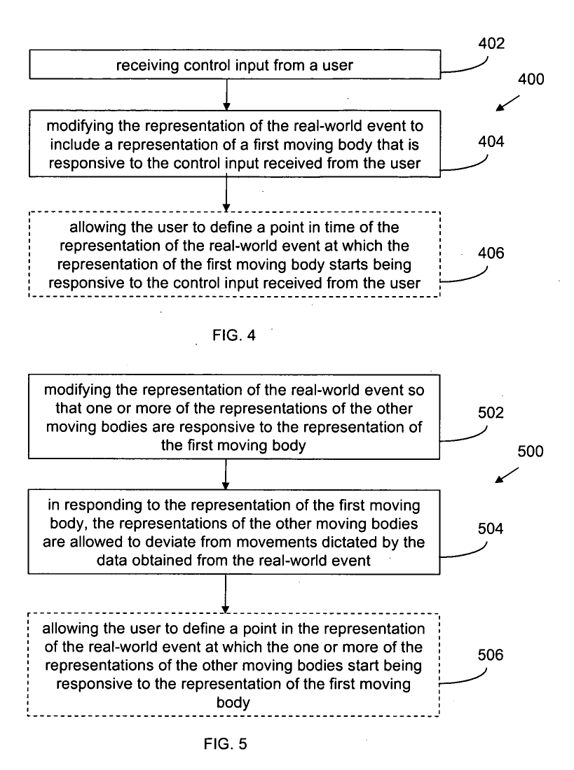

Referring to FIG. 4, there is illustrated a method 400 that operates in accordance with an embodiment of the present invention. The method 400 may be used for allowing further user manipulation of the representation of the real world event. The method 400 begins in step 402 in which control input is received from a user.

Various control inputs may be received by the user. In particular, the user provides control input regarding one of the representations of the moving bodies. Control input may include selecting one of the representations of the moving bodies, such as a representation of a first moving body. The user may provide control input regarding the movement of the first moving body within the representation of the real-world event.

In step 404, the representation of the real-world event which includes the representation of the first moving body that is responsive to the control input is modified. The representation of the first moving body within the representation of the real-world event is responsive to the control input of the user. For example, the control input from the user may alter the movement of the first moving body. Movement of the representation of the first moving body may include direction of movement along with the speed or acceleration of the first moving body. As the representation of the first moving body responds to the control input, the representation of the real-world event is modified and displayed to the user on the display. In some embodiments, the representation of the first moving body corresponds to a moving body in the real-world event. In other embodiments, the representation of the first moving body does not correspond to a moving body in the real-world event. In even further embodiments, the representation of the first moving body does not cause the representations of the other moving bodies to deviate from movements dictated by the data obtained from the real-world event.

In some embodiments, the method 400 includes step 406. In step 406, the user is allowed to define a point in time of the representation of the real-world event at which the representation of the first moving body starts being responsive to the control input received from the user. The user may provide further control inputs as to what point in time during the representation of the real-world event which the user begins to control the representation of the first moving body. In one embodiment, the representation of the real-world event is being rendered and displayed and the user decides to control the representation to the first moving body at the point in time which is being displayed. In another embodiment, the user chooses a point in time to control the representation of the first moving body and then the rendering and displaying of the representation of the real-world event begins at the user selected point in time.

In some embodiments, the real-world event is a vehicle racing event and the representation of the real-world event is a representation of the vehicle racing event, along with all the participating vehicles. The user may provide control input as to which vehicle within the representation of the real-world event will be responsive to the control input. Once selected, the chosen vehicle will be responsive to the control inputs provided by the user. In the case of a racing event, the user may provide control inputs which control the movements of the chosen vehicle in the representation of the racing event. For example, the user may interact with the representation of the racing event by controlling the direction and the speed of the vehicle during the representation of the racing event.

Additionally, the user may choose the point in time during the representation of the racing event which the user takes control of the chosen vehicle. In the racing context, this may be a “what-if” scenario. Typically, racing events are lengthy and therefore the representation of the racing event would also be lengthy. The user may choose to interact at which point during the representation of the racing event to begin interaction with the representation of the racing event, or to begin controlling the chosen vehicle within the representation of the racing event. The user may choose to begin control of the chosen vehicle at the last laps of the racing event, or the user may choose to begin control of the chosen vehicle at a particularly exciting point of the racing event. In the racing context, this may be a “what-if” scenario. The user may think, “what if I was driving that F1 car in Brazil instead of Hamilton, would I have pitted and won the race and the F1 series?” By utilizing embodiments of the present invention, the user may view the representation of the F1 race in Brazil, and then interact with the representation of the F1 race in Brazil at any point in time of the race. The user may relive the final laps of the F1 race in Brazil by participating in the representation of the F1 race and controlling a vehicle within the race.

In one embodiment, the first moving body which the user controls does not correspond to a moving body in the real-world event. In the racing context, the user may control an additional vehicle in the representation of the racing event which does not correspond to one of the vehicles which participated in the real-world (racing) event. In this sense, the user may act as an additional racer in the racing event who competes against the other racers in the racing event. For example, the user may try too see whether or not the user could beat the current leader of the race so the user could position a vehicle right behind the leader to determine whether they could have beat the leader.

In another embodiment, the representation of the first moving body which the user controls does correspond to a moving body in the real-world event. In the racing context, the user may control one of the vehicles in the representation of the racing event which does correspond to one of the vehicles which participated in the real-world racing event. In this sense, the user may act as one of the racers in the racing event. For the “what-if” scenario, the user may act as one of the racers which originally participated in the racing event in the representation of the racing event. As the user plays as the racer, the user may attempt to follow the original line taken by the racer in the real-world racing event in the representation of the real-world racing event.

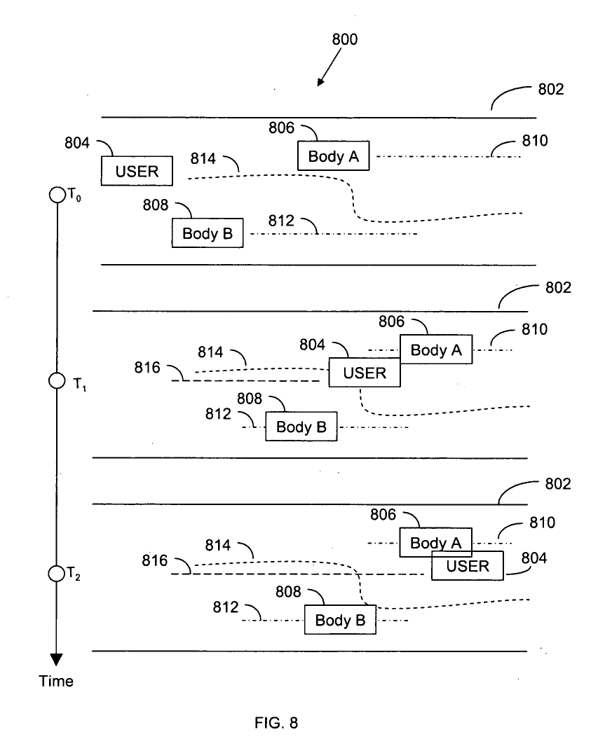

In a further embodiment, the representation of the first moving body does not cause the representations of the other moving bodies within the representation of the real-world event to deviate from movements dictated by the data obtained from the real-world event. The data obtained from the real-world event, such as a racing event, is utilized to generate the representation of the real-world event and the moving bodies within the representation of the real-world event (and the real-world event itself). As the user controls the representation of the first moving body, the first moving body does not alter the movements of the representations of the other moving bodies (as illustrated with respect to FIG. 8). For a racing event with vehicles, the user may compete against ghost vehicles. In this mode, the user would control their vehicle through the other vehicles. The other vehicles utilize the obtained data from the racing event for controlling their movements within the representation of the racing event while the in-game physics engine would be utilized for the vehicle controlled by the user.

In even further embodiments, the one of more representations of the other moving bodies may respond to the first moving body controlled by the user as outlined with respect to FIG. 5.

Referring to FIG. 5, there is illustrated a method 500 that operates in accordance with an embodiment of the present invention. The method 500 may be used for allowing further interaction between the user and the representation of the real-world event. The method 500 beings in step 502 in which the representation of the real-world event is modified so one or more of the representations of the other moving bodies are responsive to the representation of the first moving body.

As discussed above, the first moving body is responsive to user input controls and the first moving body may or may not correspond to a moving body in the real-world event. As the obtained data is utilized to generate the representation of the real-world event and the moving bodies within the real-world event, the user may control the first moving body in the representation of the real-world event. In one embodiment, the representations of the other moving bodies are responsive to the representation of the first moving body. As the other moving bodies respond to the first moving body, the representation of the real-world event is modified.

At step 504, in responding to the representation of the first-moving body, the representations of the other moving bodies are allowed to deviate from the movements dictated by the data obtained from the real-world event. The data obtained from the real-world event is utilized to generate the representation of the real-world event and the moving bodies. However, as the user controlled first moving body interacts with the representation of the other moving bodies and the other moving bodies are responsive, then the movements of the representations of the other moving bodies are allowed to deviate from the movements dictated by the obtained data. In the racing context, when the user controlled vehicle begins to interact with the other vehicles in the race (for example, by hitting or running into another car) the movement of the other vehicles which interact with the user controlled vehicle begin to deviate from the obtained data of the racing event. In one embodiment, from the point which the user beings to interact with the other vehicles, the movement of the other vehicles may utilize a combination of the obtained data and the physics from the game. In some embodiments, from the point which the user beings to interact with the other vehicles, the movement of the other vehicles maybe controlled by the artificial intelligence (AI) of the computer simulation.

n some embodiments, the responsiveness of the representations of the other moving bodies to the representation of the first moving body is controlled by an artificial intelligence (AI) of the computer simulation. The AI of the computer simulation may utilize a combination of the control input received from the user and the data obtained from the real-world event to control the responsiveness of the other moving bodies.

In one embodiment, the representation of the first moving body corresponds to a moving body in the real-world event and the modifying of the real-world event further comprises modifying the representation of the real-world event such that the representations of the other moving bodies substantially track the movements dictated by the data obtained from the real-world event if the user controls the representation of the first moving body so that it substantially tracks the movements dictated by the data obtained from the real-world event. For the racing context and the “what if” scenario, the user may have seen an interesting move performed at the racing event and the user would like to attempt the move himself (or herself). The representation of the racing event is generated and the user plays as the vehicle which performed the interesting move. The user attempts to substantially track the movements of the vehicle which performed the interesting move. As the user substantially tracks the movements of the vehicle, the representations of other vehicles in the race substantially track the movements dictated by the obtained data of the racing event since the user is attempting to mimic the vehicle which performed the interesting move.

In another embodiment, the representation of the first moving body corresponds to a moving body in the real-world event and the modifying the representation of the real-world event further comprises modifying the representation of the real-world event so that the representations of one or more of the other moving bodies deviate from the movements dictated by the data obtained from the real-world event if the user controls the representation of the first moving body so that it deviates from the movements dictated by the data obtained from the real-world event. For the racing context and the “what if” scenario, the user may have seen an interesting move performed at the racing event and the user would like to attempt the move himself (or herself). The representation of the racing event is generated and the user plays as the vehicle which performed the interesting move. The user attempts to track the vehicle, however as the user deviates from the original movements dictated by the obtained data of the vehicle, the representations of the other vehicles in the racing event also deviate from the movements dictated by the obtained data.

In some embodiments, the method 500 includes step 506. In step 506, the user is allowed to define a point in time of the representation of the real-world event at which the representation of the other moving bodies start being responsive to the representation of the first moving body. The user may provide control inputs as to what point in time during the representation of the real-world event which the representations of the other moving bodies start being responsive to the user controlled representation of the first moving body. In one embodiment, the representation of the real-world event is being rendered and displayed and the user decides to control the representation to the first moving body and for the representations of the other moving bodies to be responsive to the first moving body at the point in time which is being displayed. In another embodiment, the user chooses a point in time which the representations of the other moving bodies start being responsive to the representation of the first moving body then the rendering and displaying of the representation of the real-world event begins at the user selected point in time. In the racing context, the user may decide which point during the representation of the racing event which the representations of the other vehicles is responsive to the representation of the vehicle controlled by the user.

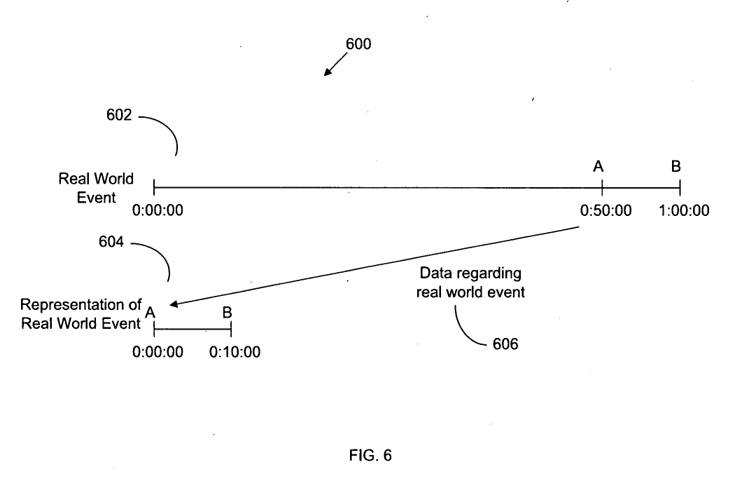

Referring to FIG. 6, there is illustrated a timing diagram 600 in accordance with one embodiment of the present invention. The timing diagram 600 illustrates one embodiment which the user may define a point in time which the representation of the first moving body may be controlled by the user or the representations of the other moving bodies may be responsive to the first moving body or both. The timing diagram 600 comprises a real-world event time bar 602, a representation time bar 604, and data stream 606.

The real-world event may be an hour long event, as illustrated by the real-world event time bar 602. As such, the representation of the real-world event may also be of an hour length (essentially, the length of the real-world event). In some embodiments, the user may want to interact with the last portion of the real-world event (in the racing context, the end is typically the more exciting portion), from point A to point B as illustrated in FIG. 6. For example, this span of time may be of 10 minute length. Although, it should be appreciated that the user may begin interaction with the representation of the real-world event at any point in time for any given length of time.

The generating and rendering of the representation of the real-world event may be truncated to the representation of the real-world event between point A and point B, as illustrated by the representation time bar 604. The obtained data between point A and point B from the real-world event is then utilized to generate the representation of the real-world event between point A and point B, as illustrated by data stream 606.

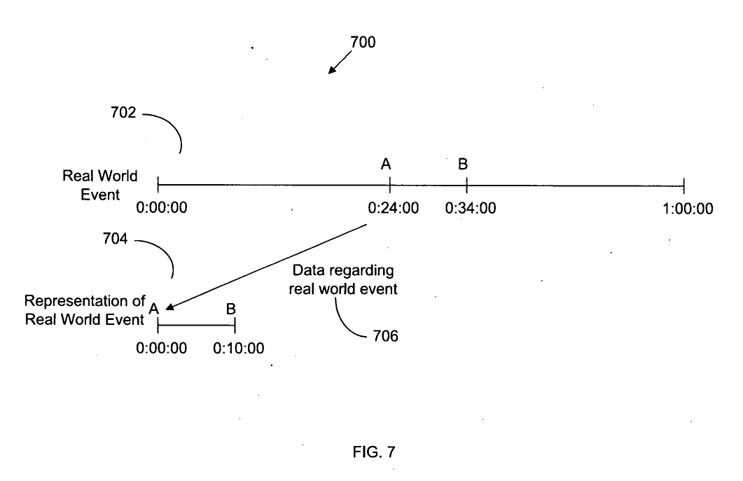

Similar to the timing diagram 600 of FIG. 6, the timing diagram 700 of FIG. 7 illustrates another embodiment which the user may define a point in time which the representation of the first moving body may be controlled by the user or the representations of the other moving bodies may be responsive to the first moving body or both. The timing diagram 700 comprises a real-world event time bar 702, a representation time bar 704, and data stream 706.

The timing diagram for FIG. 7 illustrates the user choosing a point in the middle of the real-world event/representation of the real-world event which the user would like to interact with. For FIG. 7, this point begins at the twenty four minute mark indicated by point A and ends at the 34 minute mark indicated by point B. The obtained data between points A and B are utilized to generate the representation of the real-world event between points A and B, illustrated as data stream 706. The generating and rendering of the representation of the real-world event may be truncated to the representation of the real-world event between point A and point B, as illustrated by the representation time bar 704. It should be appreciated that the user may begin interaction with the representation of the real-world event at any point in time for any given length of time.

Referring to FIG. 8, there is illustrated a timing diagram 800 which illustrates the movement and interaction of a user controlled representation of a first moving body with representations of other moving bodies in a representation of a real-world event. In particular, FIG. 8 illustrates the representation of the user controlled moving body does not cause the representations of the other moving bodies within the representation of the real-world event 802 to deviate from movements dictated by the data obtained from the real-world event, such as a ghosting mode.

At an initial point in time T₀, the representation of the real-world event 802 comprises the moving body of the user 804 as it begins to interact with the other representations of moving bodies such as body A 806 and body B 808. In addition, the representation of the moving body of the user 804 responds to user controls. Path A 810 and path B 812 correspond to the path of movement which body A 806 and body B 808 dictated by the obtained data of the real-world event, respectively. In one embodiment, the representation of the moving body of the user 804 corresponds to a moving body in the real-world event and the original path 814 corresponds to the path of movement taken by the moving body in the real-world event. In another embodiment, the original path 814 corresponds to a path of movement taken by another user or a moving body in the real-world event which the user is attempting to emulate. In the racing context, the user may attempt a “what if” scenario to play as a racer in the racing event or to attempt to track the movements of the racer.

At a next point in time T₁, the user 804 has moved along the track of the representation of the real-world event. User path 816 illustrates the path of movement for the representation of the user controlled moving body 804 as the user provides control inputs. Both body A 806 and body B 808 continue to move along path A 810 and path B 812 respectively. At this point in time T₁, the representation of the user controlled moving body 804 just begins to interact with body A 806. In the racing context, the user controlled moving body 804 just begins to contact body A 806.

In one embodiment when the user controlled moving body 804 corresponds to a moving body in the real-world event, as the user controls the representation of the user moving body 804 the user has deviated from the original path 814 set by a moving body in the real-world event or by another user.

At a subsequent point in time T₂ after the representation of the user controlled moving body 804 just begins to interact with body A 806, the representation of the user controlled moving body 804 continues upon the user path 816 and does not cause body A 806 and body B 808 to diverge from their paths dictated by the obtained data of the real-world event. As shown in FIG. 8, the representation of the user controlled moving body 804 passes through body A 806 without causing body A 806 to diverge from path A 810.

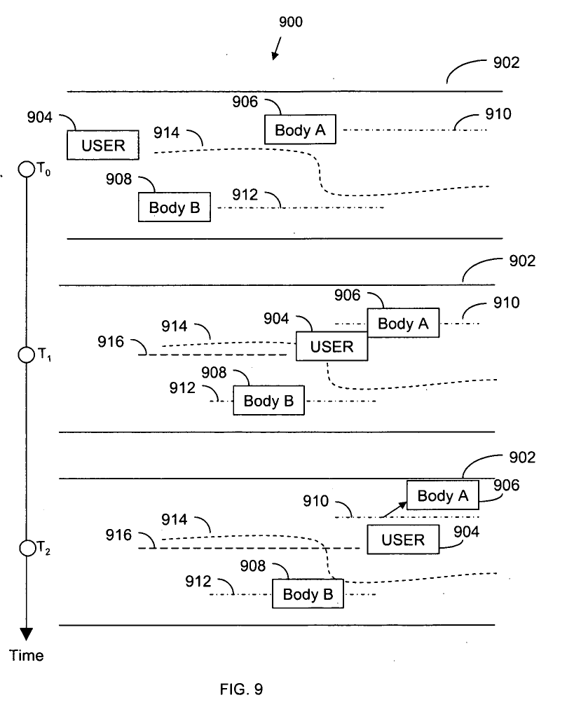

FIG. 9 illustrates a timing diagram 900 which illustrates the movement and interaction of a user controlled representation of a first moving body with representations of other moving bodies in a representation of a real-world event. In particular, FIG. 9 illustrates when the representations of other moving bodies respond to the representation of the first moving body and is allowed to deviate from movements dictated by the obtained data.

At an initial point in time T₀, the representation of the real-world event 902 comprises the moving body of the user 904 as it begins to interact with the other representations of moving bodies such as body A 906 and body B 908. In addition, the representation of the moving body of the user 904 responds to user controls. Path A 910 and path B 912 correspond to the path of movement which body A 906 and body B 908 dictated by the obtained data of the real-world event, respectively. In one embodiment, when the representation of the moving body of the user 904 corresponds to a moving body in the real-world event and the original path 914 corresponds to the path of movement taken by the moving body in the real-world event. In another embodiment, the original path 914 corresponds to a path of movement taken by another user or a moving body in the real-world event which the user is attempting to emulate. In the racing context, the user may attempt a “what if” scenario to play as a racer in the racing event or to attempt to track the movements of the racer.

At a next point in time T₁, the user 904 has moved along the track of the representation of the real-world event. User path 916 illustrates the path of movement for the representation of the user controlled moving body 904 as the user provides control inputs. Both body A 906 and body B 908 continue to move along path A 910 and path B 912 respectively. At this point in time T₁, the representation of the user controlled moving body 904 just begins to interact with body A 906. In the racing context, the user controlled moving body 904 just begins to contact body A 906.

In one embodiment when the user controlled moving body 904 corresponds to a moving body in the real-world event, as the user controls the representation of the user moving body 904 the user has deviated from the original path 914 set by a moving body in the real-world event or by another user.

At a subsequent point in time T₂ after the representation of the user controlled moving body 904 just begins to interact with body A 906, the representation of the user controlled moving body 904 continues moving upon the user path 916 and causes body A 906 to diverge from path A 910 (or the path dictated by the obtained data). How body A 906 responds to the user controlled moving body 904 may be controlled by the artificial intelligence of a computer simulation. The artificial intelligence uses utilizes the obtained data along with the control input of the user controlled moving body 904 to determine how body A 906 responds to the user controlled moving body 904. As shown in FIG. 9, the representation of the user controlled moving body 904 initially contacts body A 906 and body A 906 diverges from its intended path, path A 910.

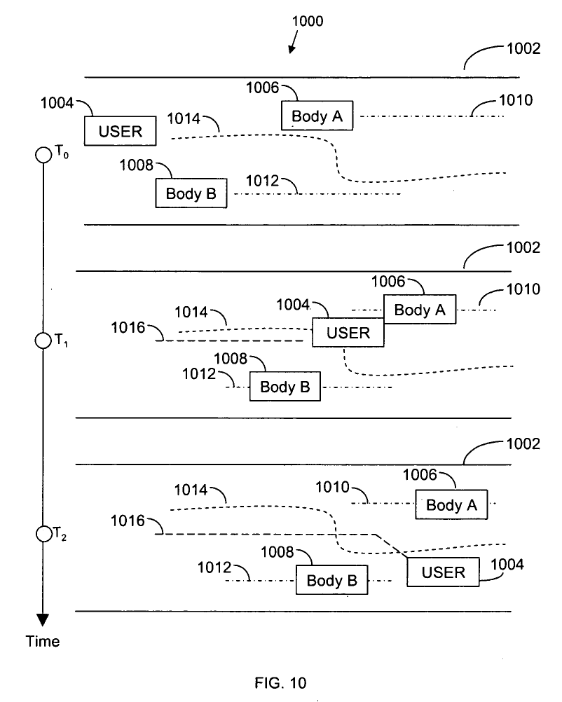

FIG. 10 illustrates a timing diagram 1000 which illustrates the movement and interaction of a user controlled representation of a first moving body with representations of other moving bodies in a representation of a real-world event. In particular, FIG. 10 illustrates when the representation of the first moving body responds to the representations of other moving bodies but the representations of the other moving bodies are not allowed to deviate from movements dictated by the obtained data.

At an initial point in time T₀, the representation of the real-world event 1002 comprises the moving body of the user 1004 as it begins to interact with the other representations of moving bodies such as body A 1006 and body B 1008. In addition, the representation of the moving body of the user 1004 responds to user controls. Path A 1010 and path B 1012 correspond to the path of movement which body A 1006 and body B 1008 dictated by the obtained data of the real-world event, respectively. In one embodiment, when the representation of the moving body of the user 1004 corresponds to a moving body in the real-world event and the original path 1014 corresponds to the path of movement taken by the moving body in the real-world event. In another embodiment, the original path 1014 corresponds to a path of movement taken by another user or a moving body in the real-world event which the user is attempting to emulate. In the racing context, the user may attempt a “what if” scenario to play as a racer in the racing event or to attempt to track the movements of the racer.

At a next point in time T₁, the user controlled moving body 1004 has moved along the track of the representation of the real-world event. User path 1016 illustrates the path of movement for the representation of the user controlled moving body 1004 as the user provides control inputs. Both body A 1006 and body B 1008 continue to move along path A 1010 and path B 1012 respectively. At this point in time T₁, the representation of the user controlled moving body 1004 just begins to interact with body A 1006. In the racing context, the user controlled moving body 1004 just begins to contact body A 1006.

In one embodiment when the user controlled moving body 1004 corresponds to a moving body in the real-world event, as the user controls the representation of the user moving body 1004 the user has deviated from the original path 1014 set by a moving body in the real-world event or by another user.

At a subsequent point in time T₂ after the representation of the user controlled moving body 1004 just begins to interact with body A 1006, body A 1006 continues along path A 1010 while the user controlled moving body 1004 responds to the interaction with body A 1006. As a result, the user controlled moving body 1004 veers away from body A (as illustrated by the user path 1016). How the user controlled moving body 1004 responds to body A 1006 may be controlled by the artificial intelligence of a computer simulation. The artificial intelligence uses utilizes the obtained data along with the control input of the user controlled moving body 1004 to determine how the user controlled moving body 1004 responds to body A 1006. As shown in FIG. 10, even though the user controlled moving body 1004 is responsive to the other moving bodies in the representation of the real-world event, the other moving bodies (such as body A 1006) do not deviate from the movements dictated by the obtained data.

One or more of the features and techniques described above may be extended to additional uses in some embodiments. For example, in some embodiments, once a system is in place, a GPS module can be used to record data in a player's personal car, bicycle, boat, watercraft, or other vehicle, and then downloaded to the game console so the player could race against himself or herself. The GPS module may comprise the GPS module included in a hand-held device such as a game device or mobile phone, some other portable GPS module, or any other GPS module. For example, this feature could be included in a bicycle racing game, a car racing game, etc. Namely, a gamer/player can use a GPS module to record his or her own route in a car, bicycle, boat, or other vehicle, and this can be played back and the gamer could compete with himself or herself. The playback can be sped up, so the player would not have to break traffic laws for the recording. Or it can be played live. This makes interesting street racing games, and it may be used in conjunction with track editing tools. Players can upload their real world data, and popular street racing circuits could be raced in games. For example, it may be used in a karting game where a player records actual kart information, which is then played back in a real race in the karting game.

Thus, as described above various embodiments of the present invention combine real world events with video games and other simulations. In some embodiments, electronics in vehicles is used to automatically stream information, which decreases the amount of human interaction needed to combine real world events and data. In some embodiments, the data gathered by race teams may be used in video game, and video games may use dynamic GPS information. Some embodiments may use live real world events, and some embodiments may use recorded real world events. Live events may be streamed over the Internet, so the player could play against the event live. Recorded events may either be available for download, or may be recorded by the player using a GPS module, such as the GPS module included in a hand-held device such as a game device or mobile phone.

Multiple game play modes may be used. For example, in some embodiments the data is used in conjunction with the in game physics to simulate the race from a certain point on, which provides a “what-if” type scenario, as described above. GPS data by itself is believed to be fairly accurate. Combining GPS data with some of the other data captured in a race car or other vehicle is believed to improve accuracy. For example, it is believed that the combination of accelerometers, GPS, and tachometer readings, along with the knowledge of the course, improve the reliability of the calculated position and orientation of the vehicle.

Some embodiments of the present invention are useful to a viewer or other user who does not have access to watch a particular sports game or other real world event in his or her area due to broadcast restrictions, other restrictions, etc., however that viewer does have the capability to go online, such as with a game console, entertainment system/apparatus, computer, etc. Namely, one or more of the above-described embodiments, methods and/or techniques allow a user to watch a simulation of a real world sporting event using a video game, such as a baseball video game, basketball video game, or other video games, sports video games, or computer simulations. In some embodiments, this may be referred to as game console and/or video game broadcasting of a real world event.

For example, in some embodiments a user's game console or other apparatus connects to a server and then that server sends the data needed to simulate on the game console what is actually happening in real life in the sporting event or other event. This allows a user to watch a sports event without actually looking at it on a normal TV broadcast. Instead, the user watches a simulation of the real world event in an actual video game or other computer simulation. This has an advantage of allowing the user to view the game in all angles, not just the original view provided by the TV broadcast. By way of example, some embodiments allow a user to watch a major league baseball game on a game console or other entertainment apparatus using a baseball video game, which may be desirable when the game is not being broadcasted locally on cable TV. As another example, some embodiments provide for capturing data from a real world race, such as an automobile race, and then simulating the race in a video game so that it is actually representative of the real world race inside of the video game application. Embodiments of the present invention may be applied to many different types of real world events, such as for example sporting games, races, tournaments, and events, rock concerts, music performances, theatrical performances, and other real world events.

As mentioned above, some embodiments allow the user to view the simulated real world event in many different angles. Using a video game's 3D engine gives the viewer a unique experience to view the action in the simulated real world event from any angle. For example, a user may view the event from any seat in the stadium or from anywhere in the stadium. This currently is not possible with TV. Additionally, some embodiments allow the user to use the game engine to view replays and look at things in slow motion from any position as well. Likewise, in some embodiments if the video game supports networking, a user can watch the simulation of the real world event with others over the internet and then communicate together via text chat, voice chat, or other interfaces that the game supports, such as for example a whiteboard, telestrator, etc.

Some embodiments of the present invention provide a unique application of technologies to provide a whole new entertainment experience. For example, in some embodiments several different technologies are merged together into one system, including capturing real world data, processing that data, and then using a network to transmit that data to other individuals. In this way a 3D rendered simulation is used to actually depict an event that takes place in the real world.

Data acquisition may be performed in any of several different ways. For example, in some embodiments the data needed for generating a simulation within a video game may be based on accelerometer and GPS information, as described above. That is, players, people (i.e. human beings), vehicles, etc., or other moving bodies, in the real world event may be tracked using GPS information, accelerometers, and/or similar devices.

In some embodiments, motion capture techniques are used to acquire the data needed for generating a simulation. Namely, various devices may be attached to players, people, vehicles, etc., or other moving bodies, in the real world event, and then motion capture may be used to capture the movements of the bodies. The types of devices used for the motion capture may depend upon the environment. For example, in a baseball game an accelerometer may be embedded in a player's helmet or hat. Likewise, a player's uniform, glove, and/or shoes may contain small GPS devices to facilitate the gathering of information in real time about the position and movement of the player. In some embodiments, an object like a glove, a ball, or a piece of cloth may be marked in a manner that allows another device to record the appropriate information. For example, objects that give off heat can be tracked via infrared. Infrared may be used to track objects in the real world event which are in motion and which are going to be simulated within the context of a sports game or other environment in a game.

In some embodiments, the data needed for generating a simulation within a video game or other computer simulation may be obtained from the actual video of the real world event. That is, the TV or other video signal is captured and converted into data or a graphically generated video feed that is usable in a video game or other computer simulation. For example, in some embodiments the actual video of the real world event is analyzed to extract or otherwise generate the data, such as position data for the players, vehicles, or other moving bodies. The extracted data is then translated into data usable by the video game or other computer simulation. TV broadcasts typically include multiple cameras which each capture the real world event. In some embodiments, the multiple video feeds are analyzed via a computer program or other analysis tool to generate important information and turn it into raw data of object coordinates, velocity, acceleration, and position. Using video data may not be the most accurate way to gather this information since video does not always capture every event that may be desirable for creating a simulation. But in some embodiments using video data may mean that fewer tracking devices, if any, would need to be attached to players. In some embodiments, the audio from the video feed may be used verbatim or partially used for the simulation. Furthermore, in some embodiments both video and sound from the real world event may be used in the simulation.

Once the data needed for generating a simulation is gathered it can then be fed into the video game or other computer simulation. There, the real world coordinates are mapped to the game world's coordinate mapping system and a simulation of the real world event is generated. In some embodiments, the game then sends the data over the network using its replay engine. Alternatively, in some embodiments the game feeds back the raw data and has each client interpret the data locally.

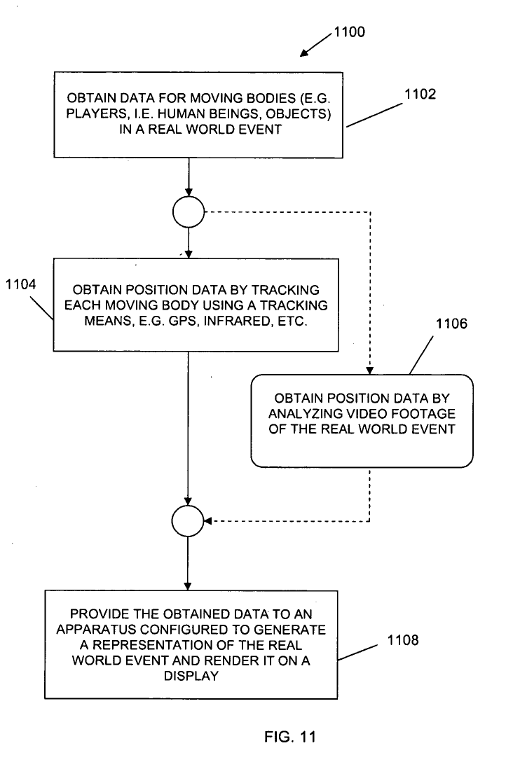

FIG. 11 illustrates a method 1100 that operates in accordance with an embodiment of the present invention. The method 1100 illustrates examples of several of the above-mentioned data acquisition techniques. Specifically, in step 1102 the process of obtaining data for each of a plurality of moving bodies in a real-world event begins. As mentioned above, the moving bodies may comprise human beings, such as players in a sporting event, and/or objects used in the event, such as a baseball, football, basketball, hockey puck, etc., and/or vehicles, etc. Data for any combinations of such moving bodies may be obtained.

In some embodiments, the real-world event takes place over a period of time, and the data, such as position data, is obtained at a plurality of points in the period of time. In some embodiments, the real-world event comprises an event that is broadcast on television to at least some viewers. For example, the real-world event may comprise a sporting event that is broadcast on television only locally in one city, county, state, and/or region. A viewer outside of the broadcast area may wish to use the methods and techniques described herein to watch the event in a computer simulation, such as a video game. Furthermore, even a viewer that is inside of the broadcast area may wish to use the methods and techniques described herein to watch the event in a computer simulation given the advantages mentioned above. In some embodiments, the real-world event may comprise an event that is widely broadcast on television, such as nationally or internationally. In some embodiments, the real-world event may comprise an event that is not broadcast on television at al.

In step 1104, position data for each of the moving bodies in the real-world event is obtained by tracking each of the moving bodies with a tracking means. As described above, various tracking means may be attached to the moving bodies in the real world event (e.g. players, people, vehicles, etc.), and then motion capture may be used to capture the movements of the bodies. In some embodiments, the tracking means may comprise tracking devices, such as GPS devices and modules, accelerometers, and/or other types of tracking devices. In some embodiments, the tracking means may comprise a mark used for tracking purposes. For example, the mark may be the type of mark that can be tracked using infrared tracking, as described above.

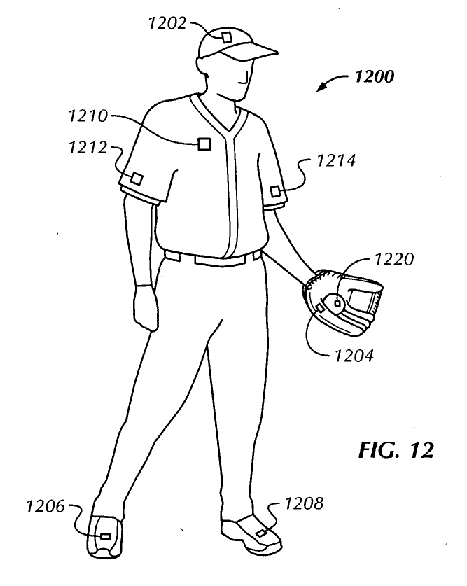

FIG. 12 illustrates examples of various tracking means that may be attached to a moving body 1200, in accordance with embodiments of the present invention. Specifically, in this example embodiment the moving body 1200 comprises a human being, and more specifically, a baseball player. One or more tracking means may be attached to one or more items worn by the player 1200. Furthermore, more than one tracking means may be attached to the player 1200.

For example, in some embodiments an accelerometer or GPS device 1202 may be attached or embedded in the player 1200's hat. In some embodiments, an accelerometer or GPS device 1204 may be attached or embedded in the baseball glove worn by the player 1200. In some embodiments, accelerometer or GPS devices 1206 and 1208 may be attached or embedded in the shoes worn by the player 1200. As another example, in some embodiments a mark 1210 used for tracking purposes may be placed on the uniform worn by the player 1200. The mark may be placed at any location on the uniform or other item worn by the player 1200. As another example, marks 1212 and 1214 used for tracking purposes may be placed on the player 1200's uniform at one or both sleeves. Such marks may comprises the type of marks that can be tracked using infrared tracking. And as mentioned above, tracking means may also be attached to other moving bodies such as objects used in the real world event. For example, a tracking device or mark 1220 may be attached to the baseball shown in the player 1200's glove. It should be well understood that the various tracking means that are shown attached to the player 1200 are just examples and that any number, any attachment location, and/or any combination of devices and marks may be used.

Returning to the method 1100 (FIG. 11), in step 1108 the obtained data, which may include position data for the moving bodies, is provided to an apparatus that is configured to use the data to generate a representation of the real-world event and render the representation of the real-world event on a display. In some embodiments, the representation of the real-world event comprises representations of the plurality of moving bodies. In some embodiments, the apparatus may comprise a game console, entertainment apparatus or system, media center apparatus, computer, or similar apparatus. In some embodiments, the apparatus may be configured to use the data to generate a representation of the real-world event and render it on a display by running a video game application or some other computer simulation application.

Step 1106 provides an optional alternative to step 1104. That is, in some embodiments step 1106 provides an alternate way to obtain data, such as position data, for the plurality of moving bodies in the real-world event. Specifically, in step 1106 position data is obtained by analyzing video footage of the real-world event. For example, as discussed above, one or more videos of the real-world event may be analyzed. Position data is then generated or otherwise extracted based on the analyzing of the one or more videos of the real-world event. In some embodiments, a plurality of videos of the real-world event, e.g. multiple video feeds, may be analyzed to obtain the position data. The use of multiple video feeds may provide different views of the event and thus provide greater accuracy of the obtained data. In some embodiments, a combination of steps 1104 and 1106 may be used to obtain data for the plurality of moving bodies in the real-world event. That is, in some embodiments, both of steps 1104 and 1106 may be used.

In some embodiments, a video of the simulation of the real world event is generated. This may be useful for users who do not own a copy of the video game or other computer simulation. That is, for users who do not own the game but would like to just watch the simulation, a video (e.g. MPEG, AVI, etc.) is generated that can be watched from any device that supports video feedback. This would, for example, allow people to see how good the graphics, simulation, physics and sound are before purchasing the game. This would perhaps encourage people to buy the game as well since they could have more extensive replay and viewing options of the simulation of the real world event.

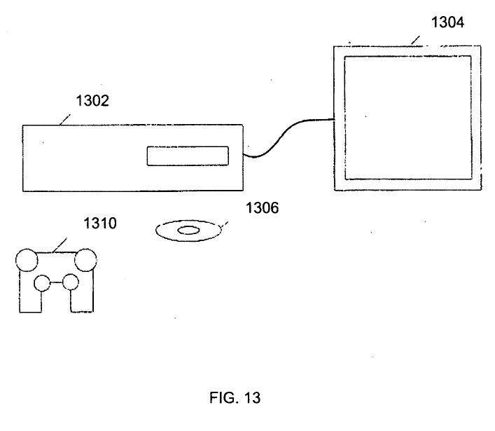

FIG. 13 is a block diagram illustrating a system that operates in accordance with an embodiment of the present invention. As illustrated in FIG. 13, a computer, or game console, entertainment system/console 1302 may be coupled to a video display 1304 such as a television or other type of visual display. A game or other simulations may be stored on a storage media 1306 such as a Blu-ray disc, DVD, a CD, flash memory, USB memory or other type of memory media. The storage media 1306 can be inserted to the console 1302 where it is read. The console can then read program instructions stored on the storage media and present a game interface to the user.

Typically, a user or player manipulates an input device such as a game controller 1310 to control and interact with the video game or other simulation. The game controller 1310 may include conventional controls, for example, control input devices such as joysticks, buttons and the like. In addition, the game controller 1310 can include an internal sensor, for example an accelerometer, which produces signals in response to the position motion orientation or change in orientation of the game controller 1310. The phrase game controller is used to describe any type of Human Input Device (HID) or other input device used to interact with a game. The phrase game console is used to describe any type of computer, computing device, or game system that can execute a game program.

During operation of the console 1302 when user is playing a game, the user can use the game controller 1310 to interact with the game. For example, the user may push buttons, or uses a joystick on the controller 1310 to interact with the game. In addition, the user can move the controller 1310 in a direction such as up, down, to one side, to the other side, twisted, wedged, shaken, jerked, punched, etc. In addition to using the controller to interact with the game, use of buttons, joysticks, and movements of the controller 1310, and the like, may be detected and captured in the game console 1302 for analysis of the user's game performance.

In general, signals from the game controller 1310 are used to generate positions and orientation data that may be used to calculate many physical aspects of the user's interaction with the game. Certain movement patterns or gestures for the controller 1310 may be predefined and used as input commands for the game or other simulation. For example, a plunging downward gesture of the controller 1310 may be defined as one command, a twisting gesture of the controller 1310 may be defined as another command, a shaking gesture of the controller 1310 may be defined as still another command, and so on. In this way the manner in which the user physically moves the controller 1310 can be used as an input for controlling the game which provides more pleasurable and stimulating experience for the user.

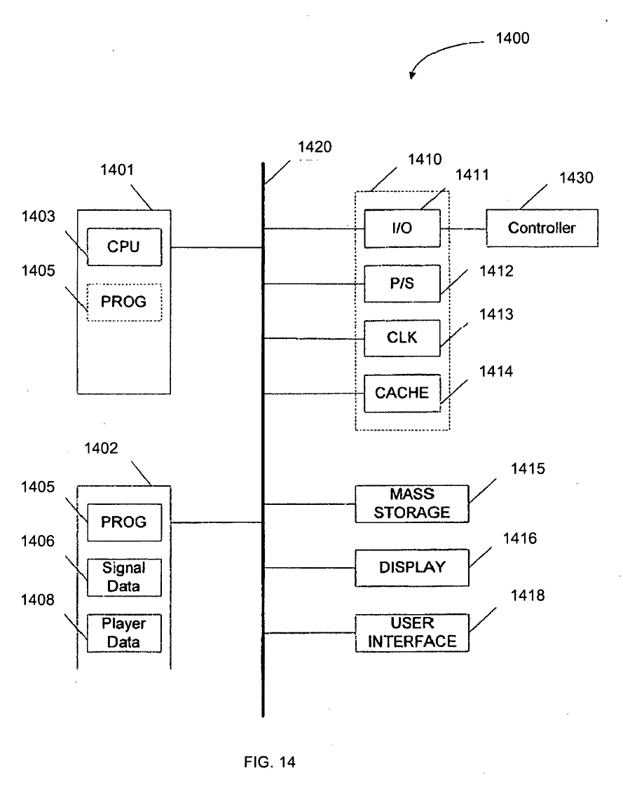

FIG. 14 is a block diagram of a system/apparatus 1400 that may be used to implement various embodiments described herein. For example, the system/apparatus 1400 may be used to generate and render a representation of a real world event using data obtained from the real-world event as described above. By way of example, the system/apparatus 1400 may comprise a game console, gaming system/apparatus, entertainment apparatus/system, computer, etc.

The system/apparatus 1400 comprises an example of a processor based system/apparatus. As shown in FIG. 14, the system 1400 may include a processor module 1401 and a memory module 1402. In one embodiment, memory module 1402 may be RAM, DRAM, ROM and the like. In addition, the system 1400 may have multiple processor modules 1401 if parallel processing is to be implemented. The processor module 1401 can include a central processing unit (CPU) 1403. In addition, the processor module 1401 can include local storage or a cache to store executable programs.

The memory module 1402 can include game program storage 1405. In addition, the memory module 1402 can include signal data storage 1406, for example, signal data acquired from game controller operated by a user. The memory module 1402 can also include player data 1408 such as player profile data as well as game statistics that may be provided.

The system 1400 may also include well-known support function module 1410 such as input/output elements 1411, power supplies 1412, a clock 1413, in cache memory 1414. The system 1400 may also optionally include mass storage module 1415 such as a disc drive, Blu-ray disc drive, CD ROM drive, DVD drive, tape drive or the like to store programs and/or data. The mass storage module 1415, which may include removable storage media, may be used for storing code that implements the methods and techniques described herein. It should be understood that any of such storage devices mentioned herein may serve as a tangible computer readable storage medium for storing or embodying a computer program for causing a console, apparatus, system, computer, or other processor based system to execute or perform the steps of any of the methods, code, and/or techniques described herein. Furthermore, any of the storage devices, such as the RAM or mass storage module, may be used for storing any needed database(s).

The system 1400 may also optionally include a display module 1416 as well as a user interface module 1418 to facilitate interaction between the system 1400 and the user. Display module 1416 may be in the form of a cathode ray tube, a flat panel screen or any other display module. The user interface module 1418 may include a keyboard, mouse, joystick, write pen or other device such as a microphone, video camera or other user input device. The processor, memory, and other components within the system 1400 may exchange signals such as code instructions and data with each other via a system bus 1420.

Various embodiments described may be implemented primarily in hardware, or software, or a combination of hardware and software. For example, a hardware implementation may include using, for example, components such as application specific integrated circuits (“ASICs”), or field programmable gate arrays (“FPGAs”). Implementation of a hardware state machine capable of performing the functions described herein will also be apparent to those skilled in the relevant art.

The term “module” as used herein means, but is not limited to a software or hardware component, such as an FPGA or an ASIC, which performs certain tasks. A module may advantageously be configured to reside on an addressable storage medium and configured to execute on one or more network enabled devices or processors. Thus, a module may include, by way of example, components, processes, functions, attributes, procedures, subroutines, segments of program code, drivers, firmware, microcode, circuitry, data, databases, data structures, tables, arrays, variables, and the like. The functionality provided for in the components and modules may be combined into fewer components and modules or further separated into additional components and modules. Additionally, the components and modules may advantageously be implemented to execute on one or more network enabled devices or computers.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a Blu-ray disc, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

By way of example, in some embodiments a storage medium may store a computer program executable by a processor based system/apparatus. The computer program may be configured to cause the processor based system to execute steps comprising any of the methods and/or techniques described herein. For example, in some embodiments, one or more of the embodiments, methods, approaches, and/or techniques described above may be implemented in a computer program executable by a processor based system/apparatus. By way of example, such processor based system/apparatus may comprise the processor based system/apparatus 1400, a similar apparatus, or a computer, entertainment system, game console, etc. Such computer program may be used for executing various steps and/or features of the above-described methods and/or techniques. That is, the computer program may be adapted to cause or configure a processor based system to execute and achieve the functions described above. For example, such computer program may be used for implementing any embodiment of the above-described methods and techniques, such as for example, receiving data obtained from a real-world event, generating a representation of the real-world event using the data, and rendering the representation of the real-world event on a display. As another example, such computer program may be used for implementing any type of tool or similar utility that uses any one or more of the above described embodiments, methods, approaches, and/or techniques. In some embodiments, the computer program may comprise a video game, computer game, role-playing game (RPG), or other computer simulation. In some embodiments, program code modules, loops, subroutines, etc., within the computer program may be used for executing various steps and/or features of the above-described methods and/or techniques. In some embodiments, the computer program may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein. For example, in some embodiments the present invention provides a computer readable storage medium storing a computer program adapted to cause a processor based system to execute steps comprising: receiving data obtained from a real-world event that takes place over a period of time and that includes a plurality of moving bodies, wherein the data includes position data and at least one other attribute for each moving body in the plurality of moving bodies with the data being measured at a plurality of points in the period of time; generating a representation of the real-world event using the data, wherein the representation of the real-world event comprises representations of the plurality of moving bodies; and rendering the representation of the real-world event on a display.

As another example, in some embodiments the present invention provides a computer readable storage medium storing a computer program adapted to cause a processor based system to execute steps comprising: receiving data obtained from a real-world event that includes a plurality of moving bodies; wherein the real-world event takes place over a period of time and is broadcast on television to at least some viewers; and wherein the data includes position data for each moving body in the plurality of moving bodies with the data being obtained at a plurality of points in the period of time; generating a representation of the real-world event using the data, wherein the representation of the real-world event comprises representations of the plurality of moving bodies; and rendering the representation of the real-world event on a display.

As another example, in some embodiments the present invention provides a computer readable storage medium storing a computer program adapted to cause a processor based system to execute steps comprising: receiving data obtained from a real-world event that takes place over a period of time and that includes a plurality of moving bodies; wherein the data includes position data for each moving body in the plurality of moving bodies with the data being obtained at a plurality of points in the period of time; and wherein the data includes data obtained by analyzing one or more videos of the real-world event; generating a representation of the real-world event using the data, wherein the representation of the real-world event comprises representations of the plurality of moving bodies; and rendering the representation of the real-world event on a display.

As mentioned above, in some embodiments the game controller or other input device may comprise a motion sensing controller or other motion sensing input device. In some embodiments, such motion sensing controller may comprise a hand-described held controller that has the ability to have its three-dimensional movements tracked. Such tracking may be performed in many different ways. For example, such tracking may be performed through inertial, video, acoustical, or infrared analysis. Such motion sensing capabilities may also be implemented with an accelerometer or the like. As another example, such motion sensing capabilities may be implemented in some embodiments with a so-called “six-axis controller” or the like.

While the invention herein disclosed has been described by means of specific embodiments and applications thereof, numerous modifications and variations could be made thereto by those skilled in the art without departing from the scope of the invention set forth in the claims.

What is claimed is:

1. A method for use in a computer simulation, comprising:
receiving data obtained from a real-world event that takes place over a period of time and that includes a plurality of moving bodies, wherein the data includes position data and at least one other attribute for each moving body in the plurality of moving bodies with the data being measured at a plurality of points in the period of time;
generating a representation of the real-world event using the data, wherein the representation of the real-world event comprises representations of the plurality of moving bodies; and
rendering the representation of the real-world event on a display.

2. The method of claim 1, further comprising:
providing a floating camera view of the representation of the real-world event; and
allowing a user to control the floating camera view so that the user can choose a view of the representation of the real-world event that is displayed on the display.

3. The method of claim 2, wherein:
the plurality of moving bodies comprises a plurality of vehicles;
the data further comprises data relating to at least one of fuel level, tire pressure, and tachometer reading for each vehicle in the plurality of vehicles; and
the allowing the user to control the floating camera view further comprises allowing the user to view alternative views of the representation of each vehicle in the plurality of vehicles.

4. The method of claim 1, further comprising:
receiving control input from a user; and
modifying the representation of the real-world event to include a representation of a first moving body that is responsive to the control input received from the user.

5. The method of claim 4, further comprising:
allowing the user to define a point in time of the representation of the real-world event at which the representation of the first moving body starts being responsive to the control input received from the user.

6. The method of claim 4, wherein:
the representation of the first moving body does not correspond to a moving body in the real-world event.

7. The method of claim 4, wherein:
the representation of the first moving body corresponds to a moving body in the real-world event.

8. The method of claim 4, wherein:
the representation of the first moving body does not cause the representations of the other moving bodies to deviate from movements dictated by the data obtained from the real-world event.

9. The method of claim 4, wherein:
the modifying the representation of the real-world event further comprises modifying the representation of the real-world event so that one or more of the representations of the other moving bodies are responsive to the representation of the first moving body; and
in responding to the representation of the first moving body, the representations of the other moving bodies are allowed to deviate from movements dictated by the data obtained from the real-world event.

10. The method of claim 9, wherein:
the responsiveness of the representations of the other moving bodies to the representation of the first moving body is controlled by an artificial intelligence (AI) of the computer simulation.

11. The method of claim 10, wherein:
the AI of the computer simulation is driven by a combination of the control input received from the user and the data obtained from the real-world event.

12. The method of claim 9, wherein:
the representation of the first moving body corresponds to a moving body in the real-world event; and
the modifying the representation of the real-world event further comprises modifying the representation of the real-world event so that the representations of the other moving bodies substantially track the movements dictated by the data obtained from the real-world event if the user controls the representation of the first moving body so that it substantially tracks the movements dictated by the data obtained from the real-world event.

13. The method of claim 9, wherein:
the representation of the first moving body corresponds to a moving body in the real-world event; and
the modifying the representation of the real-world event further comprises modifying the representation of the real-world event so that the representations of one or more of the other moving bodies deviate from the movements dictated by the data obtained from the real-world event if the user controls the representation of the first moving body so that it deviates from the movements dictated by the data obtained from the real-world event.

14. The method of claim 9, further comprising:
allowing the user to define a point in the representation of the real-world event at which the one or more of the representations of the other moving bodies start being responsive to the representation of the first moving body.

15. A computer readable storage medium storing a computer program adapted to cause a processor based system to execute steps comprising:
receiving data obtained from a real-world event that takes place over a period of time and that includes a plurality of moving bodies, wherein the data includes position data and at least one other attribute for each moving body in the plurality of moving bodies with the data being measured at a plurality of points in the period of time;
generating a representation of the real-world event using the data, wherein the representation of the real-world event comprises representations of the plurality of moving bodies; and
rendering the representation of the real-world event on a display.

16. A method, comprising:
obtaining position data for each of a plurality of moving bodies in a real-world event that takes place over a period of time and that is broadcast on television to at least some viewers, wherein the position data is obtained at a plurality of points in the period of time; and
providing the position data to an apparatus that is configured to use the position data to generate a representation of the real-world event and render the representation of the real-world event on a display, wherein the representation of the real-world event comprises representations of the plurality of moving bodies.

17. The method of claim 16, wherein the obtaining position data comprises:
tracking each moving body in the plurality of moving bodies by using at least one tracking means attached to each moving body.

18. The method of claim 17, wherein:
at least one of the plurality of moving bodies comprises a human being; and
the at least one tracking means attached to the human being comprises a tracking device.

19. The method of claim 18, wherein the tracking device is attached to an item worn by the human being.

20. The method of claim 18, wherein a plurality of tracking devices are attached to the human being.

21. The method of claim 17, wherein:
at least one of the plurality of moving bodies comprises a human being; and
the at least one tracking means attached to the human being comprises a mark used for tracking purposes.

22. The method of claim 21, wherein the mark is tracked using infrared tracking.

23. The method of claim 16, wherein the obtaining position data comprises:
analyzing one or more videos of the real-world event; and
generating the position data based on the analyzing the one or more videos of the real-world event.

24. The method of claim 23, wherein the obtaining position data further comprises:
analyzing a plurality of videos of the real-world event.

25. The method of claim 16, wherein at least one of the plurality of moving bodies comprises an object being used in the real world event.

26. The method of claim 16, wherein:
the apparatus comprises a game console; and
the configuring of the game console comprises running a video game application.

27. A computer readable storage medium storing a computer program adapted to cause a processor based system to execute steps comprising:
receiving data obtained from a real-world event that includes a plurality of moving bodies;
wherein the real-world event takes place over a period of time and is broadcast on television to at least some viewers; and
wherein the data includes position data for each moving body in the plurality of moving bodies with the data being obtained at a plurality of points in the period of time;
generating a representation of the real-world event using the data, wherein the representation of the real-world event comprises representations of the plurality of moving bodies; and
rendering the representation of the real-world event on a display.

28. The computer readable storage medium of claim 27, wherein:
the position data includes position data obtained by tracking each moving body in the plurality of moving bodies by using at least one tracking means attached to each moving body;
at least one of the plurality of moving bodies comprises a human being; and
the at least one tracking means attached to the human being comprises a tracking means attached to an item worn by the human being.

29. The computer readable storage medium of claim 28, wherein a plurality of tracking means are attached to the human being.

30. The computer readable storage medium of claim 27, wherein the position data includes position data obtained by analyzing one or more videos of the real-world event.

31. A computer readable storage medium storing a computer program adapted to cause a processor based system to execute steps comprising:
receiving data obtained from a real-world event that takes place over a period of time and that includes a plurality of moving bodies;
wherein the data includes position data for each moving body in the plurality of moving bodies with the data being obtained at a plurality of points in the period of time; and
wherein the data includes data obtained by analyzing one or more videos of the real-world event;
generating a representation of the real-world event using the data, wherein the representation of the real-world event comprises representations of the plurality of moving bodies; and
rendering the representation of the real-world event on a display.

32. The computer readable storage medium of claim 31, wherein the data includes data obtained by analyzing a plurality of videos of the real-world event.

33. The computer readable storage medium of claim 31, wherein at least one of the plurality of moving bodies comprises a human being.
